(19) United States
(12) Patent Application Publication
(10) Pub. No.: US 2023/0124541 A1
(43) Pub. Date: Apr. 20, 2023

(54) MULTI-FUNCTION SEPARATORY FUNNEL

(71) Applicant: LAWRENCE CHANG CAI, Holmdel, NJ (US)

(72) Inventor: LAWRENCE CHANG CAI, Holmdel, NJ (US)

(21) Appl. No.: 17/505,200

(22) Filed: Oct. 19, 2021

(51) Int. Cl. B01D 29/085; B01D 29/00; B01D 24/00

(52) U.S. Cl. CPC B01D 23/28; B01D 23/02; B01D 23/20; B01D 2201/16

(57) ABSTRACT

A separatory funnel for the work up of chemical reactions, extraction or separation of liquid phases. The separatory funnel has multi-functional features, which can be used as regular separatory funnels, Erlenmeyer flasks, and filter funnels. A method is also provided of separating a mixture of at least two immiscible liquids with solids or precipitates so that the clear liquids can be separated.

### FIELD OF THE INVENTION

This invention relates to devices and methods for liquid separation.

### BACKGROUND OF THE INVENTION

In routine chemical and biochemical processes, such as solvent extraction, steam distillation and azeotropic distillation, immiscible liquids, usually an organic soluble liquid and an aqueous soluble liquid, must often be separated from each other by separatory funnels. In liquid--liquid extractions, liquids may be contacted by agitation, followed by a settling period, followed by removal of one or more layers of liquid.

In typical synthetic procedures, the reaction mixtures need a workup process as follows: the reaction mixtures are distributed between an organic and aqueous layer, then the organic layer is separated and transferred to an Erlenmeyer flask. Next, desiccants, such as sodium sulphate, magnesium sulphate, or other desiccants, are put into the Erlenmeyer flask. After a period of time, such as thirty minutes, the desiccants are filtered off by filter funnels. So a dry and transparent solution is obtained, which will be concentrated and further purified to get the target compounds.

### SUMMARY OF THE INVENTION

The present invention, in at least one embodiment, relates to an apparatus for a combined function of regular separatory funnels, Erlenmeyer flasks for drying liquid, and filter funnels. An apparatus, of at least one embodiment of the present invention, also reduces the workup time of a chemical process, which uses the same apparatus for liquid separation, drying and filtration. In at least one embodiment, a method for separating immiscible liquids from insoluble solids is also provided.

At least one embodiment of the present invention provides a novel separatory funnel, which reduces the amount of time necessary for funneling, drying, and filtering of liquids. This novel separatory funnel has the functions of a regular separatory funnel, Erlenmeyer flask and filter funnel. The usage of this funnel also eliminates the need for extra glassware, such as Erlenmeyer flask and filter funnel.

To achieve the foregoing solutions and in accordance with the purpose of one or more embodiments of the present invention, there is provided a separatory funnel comprising: a chamber having an inlet opening and an outlet opening for allowing a liquid to flow through the chamber; and a horizontally aligned filter plate disposed between the inlet opening and the outlet opening along the longitudinal axis of said chamber, said filter plate positioned such that the periphery of said filter plate is placed, stuck, and/or sealed directly to the interior wall of said chamber. The said filter plate is positioned between the inlet opening and the outlet opening, so the liquids are filtered and solids or precipitates are kept in the funnel, and clear liquid phases are obtained as either combined or separated phases .

Further in accordance with the purposes of the present invention as embodied and broadly described herein, there is provided a method for separating at least two immiscible liquids in a mixture, and then dry and filter the organic layer in one glassware, comprising the steps of: pouring the mixture through a transparent chamber having an inlet opening and an outlet opening for allowing the liquids to flow through the chamber; allowing the mixture to form at least one distinguishable interface between a lower layer of one liquid and an upper layer of another liquid; allowing the mixture to flow through a passage formed by a horizontally aligned filter plate disposed in the chamber such that at least a portion of the periphery of said baffle plate is placed directly against the interior wall of said chamber, until the one liquid has exited from said chamber leaving the liquid in the upper layer in the chamber; and regulating the flow of the one liquid in the lower layer from the chamber to separate the liquids. The upper layer, usually an organic phase, such as ethyl acetate, diethyl ether, hexane or other organic solutions, is kept in an inner chamber of the apparatus. Then desiccants, such as sodium sulphate, or magnesium sulphate, or other desiccants, are put into the inner chamber of the apparatus. The said apparatus is then shaked, swirled or flipped for a few times to let the liquid interact with desiccants. Next an outlet valve is opened to allow the mixture to flow through the filter plate, and out an outlet opening, so a transparent liquid free from water or moisture is obtained.

### BRIEF DESCRIPTION OF THE DRAWINGS

The accompanying drawings, which are incorporated in and constitute a part of the specification, illustrate the presently preferred embodiments of the present invention and, together with the general description given above and the detailed description of the preferred embodiments given below, serve to explain the principles of the invention.

FIG. 1 is a cutaway top and front perspective view of an apparatus of an embodiment of the present invention.

### DETAILED DESCRIPTION OF THE DRAWINGS

Reference will now be made in detail to the present preferred embodiments of the invention as illustrated in the accompanying drawings.

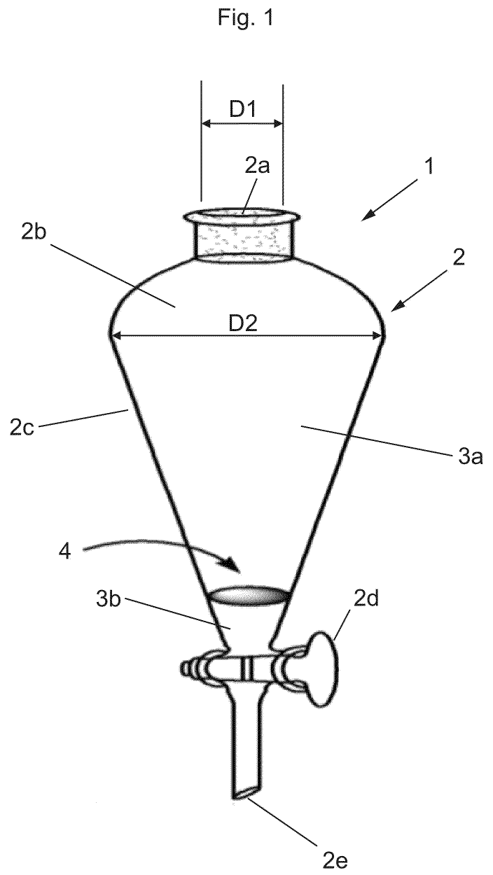

FIG. 1 shows a cutaway, top, and front perspective view of an apparatus 1 in accordance with an embodiment of the present invention, with the apparatus 1 shown in a first state.

The apparatus 1 is a combination of a known separatory funnel device 2 and a filter 4 placed within an inner chamber 2b of the known separatory funnel device 2.

The present invention, in at least one embodiment, provides the apparatus 1 of FIG. 1 for separating, drying and filtering a mixture comprising at least one liquid while funneling said mixture. Optionally, the mixture may further be comprised at least one solid. The liquid is usually the product of solvent extraction, steam distillation, or azeotropic distillation, or results from other reactions.

The known separatory funnel device 2 is comprised of an inlet opening 2a and an outlet opening 2e. The outlet opening 2e allows a liquid to flow through an inner chamber 2b. The inner chamber 2b is enclosed within an outer housing 2c, which may be made of glass. The known separatory funnel or funnel device 2 may be a known cylindrical, substantially cylindrical, or tapered cylindrical known separatory funnel device 2.

Preferably, the inner chamber 2b is wide, and may have a diameter of D2, following entrance through inlet opening 2a and tapers to a relatively narrow outlet opening 2e. In a preferred embodiment, the inner chamber 2b comprises a funnel, such as a pouring funnel or a separatory funnel. Inlet opening 2a, provided near the upper end of inner chamber 2b, may be wide as in conventional pouring funnels or relatively smaller as in separatory funnels. For example, in a five hundred ml (milliliters) separatory funnel, inlet opening for opening 2a may be about 11/8 inches in diameter D1, and may be fitted with a stopper or other type of closure to keep the mixtures inside the funnel while operating.

As shown in FIG. 1, a filter or filter plate 4 is disposed between inlet opening 2a and outlet opening 2e along the longitudinal axis of inner chamber 2b. In a preferred embodiment, filter plate 4, inlet opening 2a and outlet opening 2e are spaced along the longitudinal axis of the inner chamber 2b, and the filter plate 4 is positioned between inlet opening 2a and outlet opening 2e such that at least a portion of filter plate 4 lies in axial alignment with outlet opening 2e. Thus, a portion of filter plate 4 completely covers the space directly above outlet opening 2e as viewed along the longitudinal axis of inner chamber 2b.

Filter plate 4 is positioned such that at least a portion of the periphery of the filter plate 4 is placed directly against an interior wall of the housing 2c, and forms a porous passage for the flow of liquid therethrough. Filter plate 4 completely covers the space directly above outlet opening 2e as viewed along the longitudinal axis of the inner chamber 2b.

The apparatus of the present invention may further include means for regulating the flow of liquid from inner chamber 2b. The regulating means may comprise a variety of valves, such as a check valve or a stopcock, such as valve 2d shown in FIG. 1. Alternatively, the regulating means may comprise any member that performs a valving function.

In a preferred embodiment, filter plate 4 is placed low in the inner chamber 2b such that it is positioned along the longitudinal axis of inner chamber 2b such that the distance as measured along the longitudinal axis from the regulating means 2d to the filter plate 4 is less than 1/5 of the distance measured along the longitudinal axis from the regulating means 2d to inlet opening 2a. For example, in a 500.0 (five hundred) ml (milliliters) separatory funnel 2, filter plate 4 will typically be positioned about 0.5 inches above the stopcock or valve 2d. Filter plate 4, as shown in FIG. 1, should be thick and sturdy enough to withstand the pressure of the liquid and stirring. Generally, a coarse or extra coarse fritted glass disc is preferred to be used as the filter plate 4.

The apparatus 1 of FIG. 1 of one or more embodiments of the present invention may be constructed using many suitable materials. These include glass, metals or metal alloys or plastics. Preferably, the housing 2c is glass and the means for regulating the flow of liquid, usually a stopcock 2d, is plastic or glass. Suitable plastics are polytetrafluoroethylene, as sold by E. I. du Pont de Nemours and Company of Wilmington, Delaware under the trademark “TEFLON” (trademarked), nylon, polyethylene, polypropylene and polystyrene. Other plastics, however, may also be used and are considered to be within the scope of the present invention. In a preferred embodiment, the housing 2c for the inner chamber 2b is transparent.

The filter plate 4 may be positioned such that a periphery of said filter plate 4 is placed, stuck, or sealed directly to an interior wall of the housing 2c for the inner chamber 2b. The said filter plate 4 is typically positioned between the inlet opening 2a and the outlet opening 2e, so the liquids are filtered and solids or precipitates are kept in the funnel, in the upper layer 3a, or the area in the inner chamber 2b between inlet opening 2a and the filter 4, and clear liquid phases are obtained passing through the filter 4 into the lower layer 3b, through the outlet 2e as either combined or separated phases. The filter 4 divides the inner chamber 2b into the upper layer 3a and the lower layer 3b. The filter 4 has a three hundred sixty degree periphery which surrounds and delimits the filter 4 and which is in contact with a three hundred sixty degree inner wall of the housing 2c, so that material typically must go through the filter 4 in order to pass from the upper layer 3a into the lower layer 3b.

The filter plate 4 may be a fritted glass plate or other porous membrane, which can filter liquid. The filter plate 4 may be positioned along the longitudinal axis of the inner chamber 2b such that filter plate 4 is near or close to the outlet opening 2e.

In at least one embodiment, a method is provided for separating at least two immiscible liquids in a mixture, comprising the steps of:
(a) pouring the mixture through the inner chamber 2b within the typically transparent housing 2c having an inlet opening 2a and an outlet opening 2e;
(b) allowing the mixture to form at least one distinguishable interface between a lower layer of one immiscible liquid and an upper layer of another immiscible liquid;
(c) allowing the mixture to flow through the horizontally aligned filter plate 4, disposed in the inner chamber 2b of the housing 2c such that the periphery of said filter plate 4 is placed directly against the interior wall of said housing 2c , until the one liquid has exited from said inner chamber 2b leaving the liquid in the upper layer 3a (above the filter 4, between filter 4 and opening 2a) in the inner chamber 2b; and
(d) regulating the flow of the one liquid in the lower layer 3b (after filter 4, between filter 4 and outlet opening 2e) from the inner chamber 2b to separate the liquids. The upper layer (between filter 4 and inlet opening 2a) usually an organic phase, such as ethyl acetate, diethyl ether, hexane or other organic solutions, is kept in the inner chamber 2b, above the filter 4, between filter 4 and opening 2a, in the apparatus 1;
(e) desiccants, such as sodium sulphate, or magnesium sulphate, or other desiccants, are put into the inner chamber 2b, through the opening 2a of the apparatus 1 and thereafter a stopper or plug is placed so that it covers opening 2a to prevent material, such as liquids or solids from spilling out through the opening 2a;
(f)the said apparatus 1 is shaked, swirled or flipped for a few times, while the stopper or plug covers opening 2a, to let the liquid above the filter 4, between filter 4 and the opening 2a, interact with desiccants, above the filter 4, between filter 4 and the opening 2a; and
(g)the outlet valve 2d is opened to allow the mixture to flow from the filter plate 4, so a transparent liquid free from water or moisture is obtained from the outlet 2e.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention’s contribution to the art.

I claim:

1. A separatory funnel adapted for filtering of a mixture comprising at least two immiscible liquids, while separating said liquids, comprising:
an outer housing;
an inner chamber, within the outer housing; the inner chamber having a longitudinal axis, an inlet opening and an outlet opening for allowing the mixture to flow through the inner chamber;
and a horizontally aligned filter disposed between the inlet opening and the outlet opening along the longitudinal axis of the inner chamber, the filter positioned such that an entire three hundred and sixty degree periphery of the filter plate directly contacts an interior wall of the outer housing thereby dividing the inner chamber into an upper layer and a lower layer; and
wherein the filter is positioned between the inlet opening and the outlet opening, so that the mixture is filtered and any solids or precipitates are kept in the upper layer of the inner chamber, and clear liquid phases are obtained as either combined or separated phases and pass through the filter into the lower layer of the inner chamber.

2. The apparatus of claim 1 wherein
the filter plate is a fritted glass plate.

3. The apparatus of claim 1 wherein
the filter plate is a porous membrane that is configured to filter liquids.

4. The apparatus of claim 2 wherein
the filter plate is positioned along the longitudinal axis of the inner chamber such that the filter plate is near or closed to the outlet opening.

5. The apparatus of claim 3 wherein
the filter plate is positioned along the longitudinal axis of the inner chamber such that the filter plate is near or closed to the outlet opening.

6. A method for separating at least two immiscible liquids in a mixture, comprising the steps of:
(a) pouring the mixture through a transparent inner chamber chamber in a housing having an inlet opening and an outlet opening;
(b) allowing the mixture to form at least one distinguishable interface between a lower layer of a first immiscible liquid and an upper layer of a second immiscible liquid;
(c) allowing the mixture to flow through a horizontally aligned filter plate, disposed in the inner chamber such that a three hundred and sixty degree periphery of said filter plate is placed directly against an interior wall of the housing , until the first immiscible liquid has exited from said inner chamber leaving the second immiscible liquid in the upper layer in the inner chamber within the housing; and
(d) regulating the flow of the first immiscible liquid in the lower layer from the inner chamber to separate the liquids.

7. The method of claim 6 wherein
the second immiscible liquid in the upper layer is in an organic phase.

8. The method of claim 7 wherein
the second immiscible liquid in the upper layer is one of the group of ethyl acetate, diethyl ether, and hexane.

9. The method of claim 6 further comprising
placing dessicates within the inner chamber, after step (d).

10. The method of claim 9 wherein
the dessicates are one of the group of sodium sulphate and magnesium sulphate.

11. The method of claim 9 further comprising
agitating the inner chamber to let the second immiscible liquid in the upper layer interact with the desiccates.

12. The method of claim 11 further comprising
opening the outlet valve to allow the mixture to flow through the filter plate, so a transparent liquid free from water or moisture is obtained.
